(19) United States
(12) Patent Application Publication
(10) Pub. No.: US 2011/0105330 A1
(43) Pub. Date: May 5, 2011

(54) COMPOSITION CONTAINING GLYPHOSATE

(76) Inventor: José Carlos da Silva LEITE, Paulinia (BR)

(21) Appl. No.: 12/767,943

(22) Filed: Apr. 27, 2010

(30) Foreign Application Priority Data
Oct. 29, 2009 (BR) 018090049330

(51) Int. Cl. A01N 57/18

(52) U.S. Cl. 504/206

(57) ABSTRACT

A new and innovative formulation used as herbicide which contains n-(phosphonomethyl) glycine [glyphosate], in acid form, along with carbonates and/or bicarbonates (of ammonium, potassium, sodium, magnesium) and surfactant products, produced through the simple mixture in mixers for solid materials, such as powder, granulate and flocculate, and subsequently be extruded, palletized or submitted to any process to provide the desired physical form.

### FIELD OF THE INVENTION

This invention refers to an inventive composition applied in the agricultural field.

### BACKGROUND OF THE INVENTION

Glyphosate [n-(phosphonomethyl) glycine] is a largely used herbicide, which is already in public domain. Glyphosate has low solubility in water, being approximately 10.5 g/L (ph 1.9; 20° C.). Usually, glyphosate is transformed into a derivative salt and prepared in liquid formulation before being marketed. Glyphosate derivative salts are commonly glyphosate ammonium, glyphosate-isopropylammonium, sodium glyphosate, glyphosate-trimesium among others. Glyphosate in its liquid formulation is diluted in water before the application.

U.S. Pat. No. 3,799,758 of Mar. 26, 1974 discloses the glyphosate effect to control weeds, as well as its production process. U.S. Pat. No. 4,405,531 of Sep. 20, 1983, describes glyphosate derivative salts. Several other documents of the prior art are related to glyphosate and the technological developments related to their composition.

Table 1 below show the average composition for herbicides with glyphosate, which are currently marketed.

TABLE 1

| | Compositions existent in the market (%) | | |
|---|---|---|---|
| | Glyphosate- | Glyphosate- | Glyphosate- |
| COMPONENTS | isopropylamine | ammonium | potassium |
| Glyphosate acid | 36.0 | 36.0 | 36.0 |
| Isopropylamine | 12.5 | — | — |
| Ammonium | — | 4.0 | — |
| Potassium | — | — | 12.0 |
| hydroxide | | | |
| Surfactant | 15.0 | 15.0 | 15.0 |
| Water | 36.5 | 45.0 | 37.0 |

The analysis of the current glyphosate product and its application allows us to stress several problems of social economic and ecologic order.

Considering that this product is normally packed in 20 L plastic chemical barrels, approximately 11,500,000 chemical barrels will need to be used to store it. Being the weight of each empty barrel of about 1.2 kg, this will lead us to 13,800,000 kg of plastic (polyethylene) used.

Considering that each truck loads an average of 20,000 L of the product, a total of 11,500 trucks are needed to transport it.

Considering that the average ratio between the volume transported and the distance covered is 1,200 km/20,000 L of the product, a total of 13,800,000 Km (8575000 miles)/year are covered to transport it.

Considering that each truck consumes 1 L of diesel to 3 km (1.8 miles), a total of 4,600,000 L of diesel are consumed each year.

Considering that the burning of 1 L of diesel generates 2.67 Kg of carbonic gas emission, a total of 12,282,000 Kg/year of CO₂ are emitted in the atmosphere.

All of these problems discussed above cause a great environmental impact with the production of packages, consumption of diesel and also, the disposal of empty packages which demand a specific procedure for the washing and the transporting.

In light of the problems and drawbacks discussed above, it is largely needed a new and innovative formulation used as herbicide which contains n-(phosphonomethyl) glycine, (glyphosate), in acid form, along with carbonates and/or bicarbonates (of ammonium, potassium, sodium, magnesium) and surfactant products.

### BRIEF DESCRIPTION OF THE DRAWING

FIG. 1 is a flowchart of the production process.

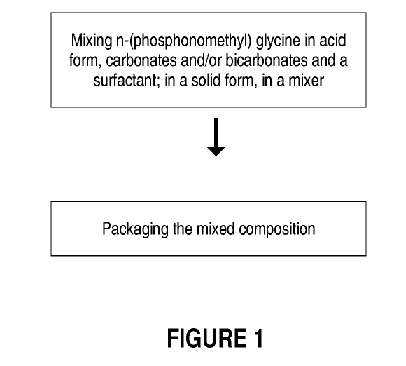

FIG. 2 is a flowchart of the production process, including the step of processing the mixed composition to provide the desired physical form.

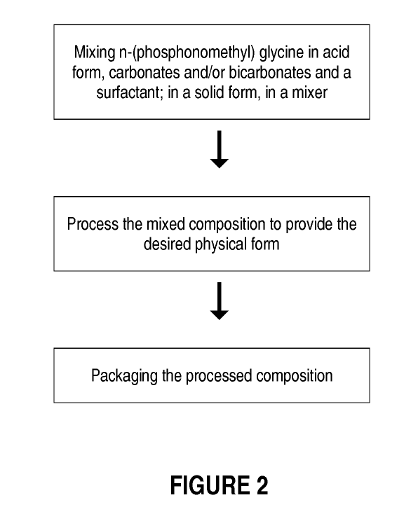

### SUMMARY OF THE INVENTION

The present application describes a composition in a solid form, comprising n-(phosphonomethyl) glycine in acid form, carbonates and/or bicarbonates and a surfactant; the carbonates and/or bicarbonates selected from ammonium carbonates, potassium carbonates, sodium carbonates and magnesium carbonates.

### DETAILED DESCRIPTION OF THE INVENTION

The innovative composition is a chemical composition that is a mixture obtained by stoichiometric balance between the components. The result is high concentrated solid products that in contact with water during dilution for application are chemically combined with each other.

The composition is translated in the form of herbicide n-(phosphonomethyl) glycine, “glyphosate” in acid form, along with carbonates and/or bicarbonates (of ammonium, potassium, sodium, magnesium) and surfactant products. By using this new composition, it is possible to assess the explicit advantages under economic and ecological optical techniques, especially when it comes to a product with more concentration. The advantages include: reducing the consumption of packages and therefore, promoting optimization of logistics and transportation costs, decreasing the amount of trucks en route, reducing accident statistics on the road, and the amount of environmental pollution generated by them.

The composition between acid herbicide, carbonates and/or bicarbonates and surfactants, discussed herewith, will be used to control weeds present in several crops. As widely known, weeds generate significant reduction in productivity for crops, damaging the farmer's production and reducing the volume of agricultural products exported, which impacts on income obtained by a country.

The compound is a solid compound which does not use water as component. This enables the packaging to be a plastic bag, and therefore, in addition to the increased product concentration, the amount of polyethylene in the manufacture of bags is a lot less than necessary to produce plastic chemical barrels. Also, due to legal requirements, empty barrels, by, are sent to specialized companies to perform decontamination the re-usage of the polyethylene in the manufacture of other products, such as, for instance, tubing for electrical installations. Again, it is necessary to use trucks to transport the empty packages.

The adoption of a balanced composition between Glyphosate acid, carbonates and/or bicarbonates and surfactant, significantly reduces the use of plastic packages and the number of trucks necessary to transport the product to the crop areas, comparatively with currently used compositions (glyphosate isopropylamine or ammonium or potassium in aqueous medium), because the composition of the present application has in average twice the concentration.

The reduction in the amount of trucks en route decreases sensibly the emission of carbonic gas in the atmosphere.

Table 2 is a comparison between two existing compositions and the composition of the present application:

TABLE 2

| | | | | Annual amount | Annual amount of CO₂ |
|---|---|---|---|---|---|
| Product | Annual amount of packages used | | | of trucks used | in the atmosphere |
| Current glyphosate | 11,500,000 chemical | 13,800,000 | Kg | 11,500 | 12,282,000 Kg |
| composition | barrels | | | | |
| glyphosate composition | 5,750,000 plastic bags | 345,000 | Kg | 5,750 | 6,141,000 Kg |
| of the present application | | | | | |
| Reduction obtained | | 13,455,000 | Kg | 5,750 | 6,141,000 Kg |

Table 3 shows the preferred embodiments for the compositions of the present application:

TABLE 3

| | Composition | Composition | Composition | Composition |
|---|---|---|---|---|
| Components | 1 (%) | 2 (%) | 3 (%) | 4 (%) |
| Acid | 40-74 | 40-64 | 40-68 | 40-72 |
| Glyphosate | | | | |
| Ammonium bi- | 10-21 | — | — | — |
| carbonate | | | | |
| Magnesium | — | 20-32 | — | — |
| carbonate | | | | |
| Potassium bi- | — | — | 16-28 | — |
| carbonate | | | | |
| Sodium bi- | — | — | — | 12-22 |
| carbonate | | | | |
| Surfactant/ | 5-50 | 4-40 | 4-44 | 6-48 |
| Inert | | | | |

In a first preferred embodiment of the invention the composition comprises 40%-74% of acid glyphosate; 10%-21% of Ammonium Bicarbonate; and 5%-50% of Inert Surfactants.

In a second preferred embodiment of the invention the composition comprises 40%-64% of acid glyphosate; 20%-32% of Magnesium Carbonate; and 4%-40% of Inert Surfactants.

In a third preferred embodiment of the invention the composition comprises 40%-68% of acid glyphosate; 16%-28% of Potassium Bicarbonate; and 4%-44% of Inert Surfactants.

In a fourth preferred embodiment of the invention the composition comprises 40%-72% of acid glyphosate; 12%-22% of Sodium Bicarbonate; and 6%-48% of Inert Surfactants.

The products obtained with the compositions of the present application, will be industrially manufactured, through simple mixture in mixers for solid materials, such as: powder, granulate, flocculate, etc. and subsequently can be extruded, palletized or submitted to any process to provide the desired physical form.

In a preferred embodiment of the process, the n-(phosphonomethyl) glycine in acid form, carbonates and/or bicarbonates and a surfactant; in a solid form, are mixed in a mixer; the mixed composition id processed to provide the desired physical form; and the processed composition is packaged.

In a second preferred embodiment of the process, the n-(phosphonomethyl) glycine in acid form, carbonates and/or bicarbonates and a surfactant; in a solid form, are mixed in a mixer; and the processed composition is packaged.

1. A composition comprising n-(phosphonomethyl) glycine in acid form, carbonates and/or bicarbonates, and a surfactant; wherein the composition is in a solid form.

2. The composition according to claim 1, wherein the carbonates are selected from the group consisting of: ammonium carbonates, potassium carbonates, sodium carbonates and magnesium carbonates.

3. The composition according to claim 1, wherein the bicarbonates are selected from the group consisting of: ammonium bicarbonates, potassium bicarbonates, sodium bicarbonates and magnesium bicarbonates.

4. The composition according to claim 1, comprising:
40%-74% of n-(phosphonomethyl) glycine in acid form;
10%-21% of ammonium bicarbonate, and
5%-50% of inert surfactants.

5. The composition according to claim 1, comprising:
40%-64% of n-(phosphonomethyl) glycine in acid form;
20%-32% of magnesium carbonate, and
4%-40% of inert surfactants.

6. The composition according to claim 1, comprising:
40%-68% of n-(phosphonomethyl) glycine in acid form;
16%-28% of potassium bicarbonate, and
4%-44% of inert surfactants.

7. The composition according to claim 1, comprising:
40%-72% of n-(phosphonomethyl) glycine in acid form;
12%-22% of sodium bicarbonate, and
6%-48% of inert surfactants.
